(19) United States
(12) Patent Application Publication
(10) Pub. No.: US 2023/0130845 A1
(43) Pub. Date: Apr. 27, 2023

(54) COMPUTER SYSTEM AND METHOD FOR FACILITATING BANKING TRANSACTIONS

(71) Applicant: Nomos Digital Limited, London (GB)

(72) Inventor: Philip Gerard MOCHAN, London (GB)

(73) Assignee: Nomos Digital Limited, London (GB)

(21) Appl. No.: 17/508,477

(22) Filed: Oct. 22, 2021

(51) Int. Cl. G06Q 20/38; G06Q 20/02; G06Q 20/10

(52) U.S. Cl. CPC G06Q 20/381; G06Q 20/027; G06Q 20/023; G06Q 20/108

(57) ABSTRACT

Disclosed herein is a computer system for controlling financial transactions between a sending entity and a receiving entity. Electronic instruction messages comprising a cross-border payment instruction are received, which define a first sender currency and a second recipient currency. A pathway of currency conversions between the sender currency and the recipient currency is selected, the selected pathway comprising selected currency providers. A first output issues settlement instructions to each of the selected providers on the selected currency conversion pathway, and a second output issues a payment instruction to the receiving entity to issue payment to a recipient in the receiving currency.

### TECHNICAL FIELD

The present invention relates to systems, methods and user interfaces for facilitating banking transactions.

### BACKGROUND

Computer systems and computer implemented methods are widely used in banking and other financial transactions. Such transactions have to be conducted speedily and accurately, with adequate security protections, which poses many technical challenges. One type of transaction with increasing demands is that of automated cross-border payments. It will be appreciated that the term cross-border transaction may refer to the transfer of funds from one currency into another and/or into a different country.

Standard contemporary methods for transferring funds across borders and into different currencies is notoriously slow and expensive. This is because international and inter-currency transactions currently require the involvement of multiple banks and depend on negotiated agreements therebetween. That is, each overall transaction can be broken down into a sequence of legal transfers between sending banks, correspondent banks and recipient banks. However, the progression of globalisation means that the demand for affordable and time-efficient cross-border transactions is also increasing from both businesses and individuals.

### SUMMARY

According to one aspect of the invention there is provided a computer system for controlling financial transactions between a sending entity and a receiving entity, the computer system comprising:
an input for receiving an electronic instruction message comprising a cross-border payment instruction defining a first sender currency and a second recipient currency;
a matching service module configured to receive transaction data from a plurality of currency providers and to select a pathway of currency conversions between the sender currency and the recipient currency, the selected pathway comprising selected currency providers;
a first output for issuing settlement instructions to each of the selected providers on the selected currency conversion pathway; and
a second output for issuing a payment instruction to the receiving entity to issue payment to a recipient in the receiving currency.

In some embodiments, the computer system of claim 1 comprises a synchronous settlement module which defines for each of multiple transaction pairs in the selected currency conversion pathway, an escrow account for receiving funds from a first currency member of each transaction pair. In such an embodiment, the synchronous settlement module may be configured to release from each escrow account the funds received from the first party of each transaction pair to the second party of each transaction pair in a settlement timeframe.

In some embodiments, the synchronous settlement module may be configured to release the funds from each escrow account contingent on each of the escrow accounts being funded. In such an embodiment, the settlement timeframe may be a defined time period after each of the escrow accounts have been funded.

In some embodiments, the computer system may comprise computer memory holding a data structure which defines each transaction pair with its associated escrow account for the selected currency conversion pathway. In such an embodiment, the computer memory may be configured to clear each transaction pair and its associated escrow account from an active memory location after the settlement timeframe.

In some embodiments, the computer system may comprise an archive memory for recording the data structure for future analysis.

In some embodiments, the computer system may be configured to receive the transaction data from multiple geographically separate locations. In such an embodiment, the separate locations may be in different countries.

In some embodiments, the computer system may be configured, where parties fail to fund an associated escrow account, to use a reputation score to assess future use of that currency provider.

In some embodiments, the second output may comprise an instruction for a domestic payment from a respondent bank in a geographical location corresponding to the location of the recipient.

In some embodiments, the transaction data may comprise price data defining the exchange rate between the currencies to be converted at each currency provider and liquidity data defining the liquidity of the currency provider.

In some embodiments, the computer system may comprise a compliance screening function configured to screen the payment instruction at the input, and create a standardised output format for presentation in a relevant manner to all eligible parties. In such an embodiment, the standardised format may be one or both of language and character set.

In some embodiments, the computer system may comprise an application programming interface (API) configured to provide transaction data to one or more client computing device via a communication network.

According to another aspect of the invention there is provided a computer device for tracking transaction details of a financial transaction, the computer device comprising:
a user interface configured to receive a cross-border payment instruction from a user;
a network interface configured to connect the computer device to a transaction system via a communication network and to transmit the payment instruction to the transaction system; and
a processor configured to receive data defining transaction steps from the transaction system when the transaction is being enacted in accordance with the payment instructions and to render graphical indicators of the respective transaction steps on a display of the user interface, wherein each graphical indicator is selectable by the user and, when selected, causes the processor to display underlying transaction information pertaining to that transaction step.

In some embodiments, the transaction steps may include receipt of the payment instruction.

In some embodiments, the transaction steps may include authorisation of the financial transaction.

In some embodiments, the transaction steps may include receipt of funds at a sending bank in the sending currency.

In some embodiments, the transaction steps may include conversion of funds into a recipient currency.

In some embodiments, the transaction steps may include receipt of funds at a recipient bank in a recipient currency.

In some embodiments, the transaction steps may include receipt of funds by a recipient entity.

In some embodiments, the transaction steps may include completion of the transaction.

In some embodiments, the computer device may be configured to provide reports to support transaction failure events and recovery of funds.

According to another aspect of the invention, there is provided a method for controlling financial transactions between a sending entity and a receiving entity, the method comprising:
receiving input of an electronic instruction message comprising a cross-border payment instruction defining a first sender currency and a second recipient currency;
receiving at a matching service module transaction data from a plurality of currency providers and selecting a pathway of currency conversions between the sender currency and the recipient currency, the selected pathway comprising selected currency providers;
issuing settlement instructions to each of the selected providers on the selected currency conversion pathway; and
issuing a payment instruction to the receiving entity to issue payment to a recipient in the receiving currency.

According to another aspect of the invention there is provided non-transitory computer readable media on which are stored computer readable instructions which, when executed by a processor of a computer device, cause the processor to implement the above method.

According to another aspect of the invention there is provided a computer system for controlling financial transactions between a sending entity and a receiving entity, the computer system comprising:
an input for receiving an electronic instruction message comprising a cross-border payment instruction defining a first sender currency and a second recipient currency;
a matching service module configured to receive transaction data from a plurality of currency providers and to select a pathway of currency conversions between the sender currency and the recipient currency, the selected pathway comprising selected currency providers; and
a fund settlement service comprising one or more hardware processor configured to send:
   a first set of instructions comprising requests to funding providers to send funds to respectively corresponding escrow account(s);
   a second set of instructions to each of multiple settlement accounts to pay out settled funds to nominated accounts of the currency providers; and
   a third instruction comprising a payment instruction to the receiving party on a domestic real time gross settlement service.

### BRIEF DESCRIPTION OF DRAWINGS

For a better understanding of the present invention and to show how the same may be carried into effect, reference will now be made by way of example to the accompanying drawings in which:

FIG. 1 shows a highly schematic diagram illustrating a contemporary method for making cross-border transactions.

FIG. 2 shows a highly schematic diagram illustrating an improved method for making cross-border transactions.

FIG. 3 shows an exemplary user interface through which a user may monitor the progress of a cross-border transaction.

FIG. 4 shows a highly schematic diagram of an overall environment for making cross-border transactions.

FIG. 5 shows a highly schematic block diagram of a client computing device.

### DETAILED DESCRIPTION

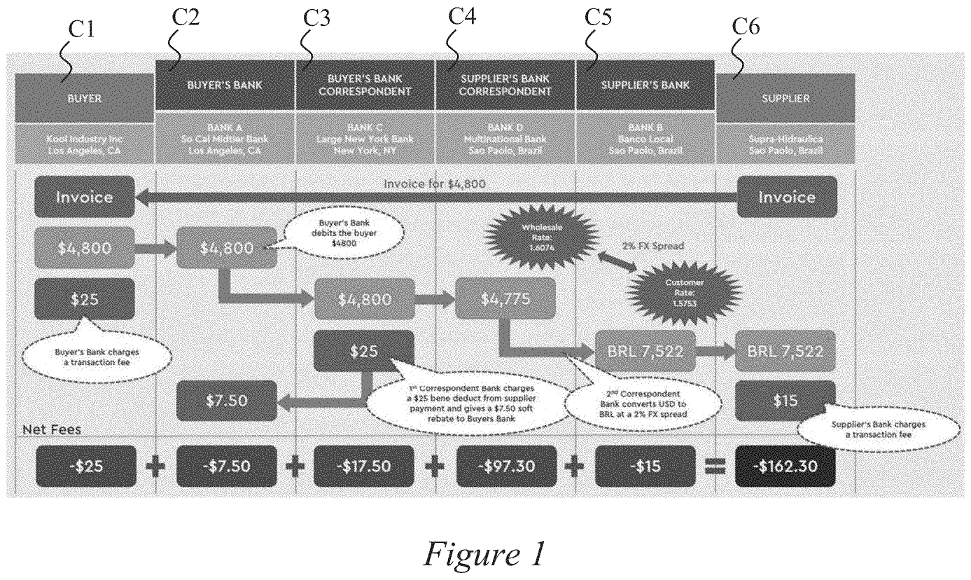

The current method by which cross-border payments between a sender and a receiver are made is now described in more detail with respect to the diagram of FIG. 1.

FIG. 1 shows a series of columns, each column representing a party involved in a cross-border transaction. Each column shows the steps in the transaction that are performed by the associated party. The parties include: a US buyer, the US buyer's bank (Bank A), a Brazilian supplier, the Brazilian supplier's bank (Bank B), and two correspondent banks: the buyer's bank's US correspondent (Bank C) and the supplier's bank's Brazilian correspondent (Bank D). The above banks may be referred to herein by their corresponding reference in parentheses (e.g. Bank A).

Bank A and Bank B may be high-street banks with whom the buyer and seller respectively hold an account. Bank A may have an agreement with Bank C, a large US-based correspondent bank, which in turn has a relationship with Bank D, a large Brazilian correspondent bank. Transfer of funds from the buyer to the seller depends on the success of several intermediate transactions between Banks A, B, C and D. Further, the agreements between banks are not subject to strict rules, rather they are negotiated. Any payment which depends on one or more such agreement is therefore subject to the fees and Foreign Exchange (FX) handling rules established by the banks themselves.

FIG. 1 shows a breakdown of a transfer of $4800 from the buyer in the US and the supplier in Brazil. Funds transferred therebetween are converted into BRL and are subject to the fees determined by inter-bank agreements and FX rates. The following description traverses the columns of FIG. 1 from left to right, breaking down fees and FX rates incurred at each step.

In column 1 (C1), the US buyer receives an invoice for $4800 and instructs Bank A, which may be the buyer's local bank, to make the payment. Bank A charges a $25 fee for the transaction. Bank A therefore debits $4825 from the buyer.

In column 2 (C2), Bank A makes a payment to Bank C, which Bank A has selected as a domestic correspondent through which to handle payments. That is, Bank A debits $4800 from the buyer's account and instructs Bank C to make the payment to Brazil. Bank C does this by debiting the account that Bank A holds with it, and crediting the equivalent value to an account held by Bank D at Bank C.

In column 4 (C4) the Brazilian correspondent bank, Bank D, is notified by the US correspondent bank, Bank C, that a domestic Brazilian transfer of funds is to be sent to the supplier's bank, Bank B, the value of the funds corresponding to the value of USD that was credited to the account owned by Bank D and held at Bank C. Bank D, as a Brazilian bank, holds funds in BRL and determines an amount thereof to be sent to Bank B based on a customer FX rate. It will be appreciated that Bank D is able to exercise considerable discretion over the rate at which the foreign exchange transaction is carried out. In the first instance, the margin, that is, the difference between the price paid by the customer for BRL and the price at which BRL are being offered for sale in the wholesale market at that time, may be set at the discretion of Bank D, or may have been determined through contractual negotiation with Bank C. In addition, Bank D is also able to choose the time at which the trade is booked and may do so at a time when the spread, that is the difference between the price bid for BRL and the price at which BRL are offered in the wholesale market, is at its widest. By maximising both spread and margin in this way, Bank D is able to maximise its revenue from the trade. However, it has the corresponding effect of causing a significant reduction in value between the amount in USD that arrives at Bank D's account with Bank C and the amount that is sent out by Bank D in BRL.

In the example of FIG. 1, Bank D books the trade at a time when the wholesale bid offer spread for USD/BRL trades is wide, at 2%, compared to earlier in the day when trading was more active, and spreads were tighter at 1%. Convention is to calculate the revenue earned from a single trade in a market that quotes prices as a spread by multiplying the difference between the mid-point of the spread and the trade price by the value of the trade. In example 1 that equates to 1% of the value of the trade. However, Bank D then applies a further margin of 1% to the wholesale offered rate available. This means that the actual rate at which the conversion is done is 1.5753 BRL per USD, compared to a wholesale rate at the time the trade was booked of 1.5914 and a best rate during the day of 1.5994. The effect is that Bank D keeps ˜2% of the value of funds it received. 2.038% of $4775 is $97.30, which is a cost incurred on the recipient because the recipient receives funds of reduced value, due to the FX rate applied by Bank D.

In the example of FIG. 1, the US correspondent bank, Bank C, compensates itself for handling the funds in the transaction by taking a $25 bene deduct from the funds received. Note that a bene deduct is a fee that is deducted by correspondent banks through which the transaction takes place; a bene deduct may often appear as a hidden cost. Whereas the transaction fee in column 1 was an additional amount to be paid by the buyer, the bene deduct is taken from the funds to be transferred, and is therefore a cost incurred on the supplier. Bank C then shares a portion of the bene deduct with the buyer's bank, Bank A, providing $7.50 to Bank A in a soft rebate. Note that the amount taken as a bene deduct and the amount given to Bank A as a soft rebate is entirely subject to the negotiated agreement between Banks A and C. These steps are illustrated in column 3 (C3) of FIG. 1.

In column 5 (C5), Bank B receives BRL7522 from Bank D, and credits that money to the supplier, charging an additional $15 transaction fee, as shown in column 6 (C6).

Overall, the cost of the transaction illustrated in FIG. 1 is $162.30, including two charges of $25 at Banks A and C, the $97.30 gained by Bank D, and the $15 fee charged by Bank B.

The high fees charged in part reflect the costs of operating using the current methods. Each correspondent bank must hold an account for each currency with another correspondent bank (known as nostro and vostro accounts); these are costly to maintain. Successful payments according to the steps shown in FIG. 1 depend on each step being carried out successfully. Each step being carried out successfully then depends on the agreements between banks. Also, because there are no direct relationships between banks in the chain, problems that do occur can be difficult to trace quickly or reliably.

Further, the money transferred out to Bank B by correspondent Bank D in BRL must move across the RTGS system of the Brazilian Central Bank. In order to make this payment, Bank D must have sufficient liquidity; that is, credit balance in its own account with the Brazilian Central Bank. A credit balance with the Central Bank may be considered to be a very low yielding asset on the balance sheet of Bank D and therefore Bank D may be expected to manage the balance to keep it is low as possible given all of the funds it expects to receive and is obliged to pay over the course of the business day. Bank D may therefore delay making the payment to Bank B for some considerable period until it judges that it has reached the most opportune time to do so, which could be on a subsequent business day. Any deadlines relating to the release of payments instructed by Bank C, and the penalties for failing to meet the deadlines, will be set in the service contract negotiated between Bank C and Bank D.

The Society for Worldwide Interbank Financial Telecommunications (SWIFT) is a network and intermediary institution used to send and receive international electronic payments. SWIFT is not itself responsible for transferring funds, but instead sends transaction order messages between banks. Each year via SWIFT, around 28 Billion messages are sent, ordering movement of around $130 Trillion, but at a cost of $220 Billion. Note that it is not solely the SWIFT messaging service that incurs this cost; it is the inefficiency of contemporary cross-border payment methods. The SWIFT system facilitates the movement of the funds, but the numbers provided above merely illustrate how costly such methods are, on the global scale at which SWIFT operates.

The cost of a cross-border payment using current methods is roughly ten times higher than the cost of a domestic payment and, as discussed previously, the former can take several days. By way of example, sending $200 as a cross border payment incurs an average cost of $13.60, and sending a $10,000 payment costs $48.70 on average. It should be noted, however, that only 10% of the cost of a payment via the correspondent model described above is technology related.

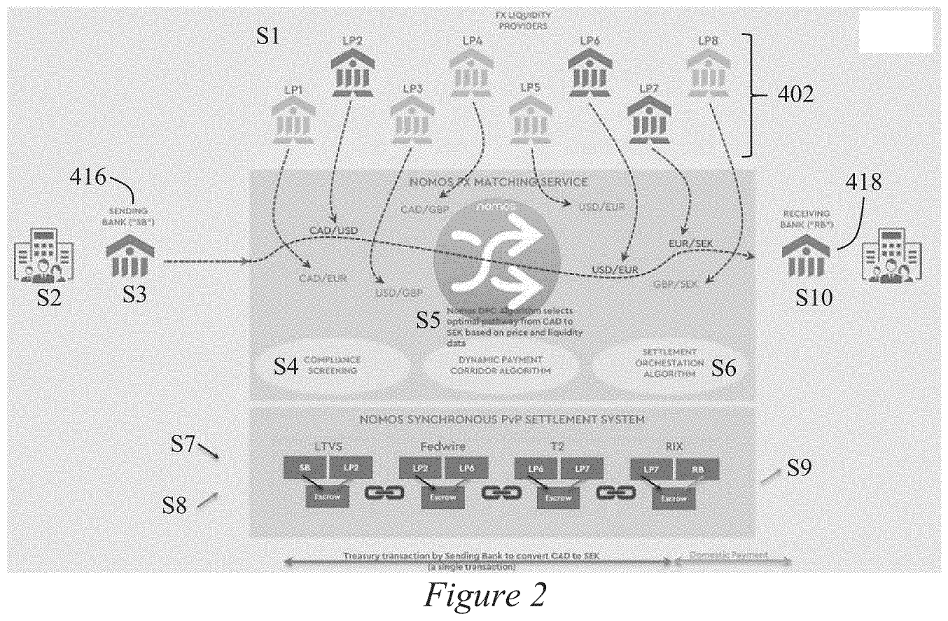

The following description relates to an improved method of facilitating cross-border payments, which reduces cost and transaction time. FIG. 2 shows a highly schematic diagram of a transaction made via this improved method. In the example of FIG. 2, a Canadian company using Canadian Dollars (CAD) intends to pay a Swedish supplier, using Swedish Krona (SEK), SEK 34m (˜CAD 5m); the steps involved in the transaction are labelled S1-S10 in FIG. 2.

At a first step S1, a plurality of liquidity providing banks 402 quote price and liquidity in their selected currency pairs; the prices and liquidity are based on funds held with central banks. In the exemplary transaction described herein, one or more of the liquidity providers 402 shown in FIG. 2 may be used to perform an FX conversion.

At a step S2, the Canadian company initiates the transaction by notifying the bank at which the funds to be transferred are held; this bank is referred to as the sending bank 416. The funds are to be sent to an account held by the Swedish supplier at a receiving bank 418. At a step S3, the sending bank 416 may communicate, via a network such as the intemet, with a computer system configured to facilitate the method described herein. Note that the facilitating computer system 406 may be operated by a third party, who is responsible for coordinating the transaction; this third party is referred to herein as the coordinating party. In some embodiments, the communication between the sending bank 416 and the facilitating computer system 406 may be made via a SWIFT message, as described previously. In other embodiments, the communication between the sending bank 416 and the facilitating computer system 406 may be direct. The communication sent between the sending bank 416 and the facilitating computer system 406 may define a sender currency, and an intended recipient currency, and may include other data pertaining to the sending party.

At a step S4, the facilitating computer system 406 may perform compliance screening processes, screening the order for sanctions, and storing data for publication to the other parties involved in the transaction.

At a step S5, the facilitating computer system 406 comprises a matching module which implements a matching service, the matching service configured to receive an indication of the sender currency and the recipient currency, and to use data provided by the liquidity provider banks 402 to determine a pathway of currency pairs from the sender currency to the recipient currency. For example, the matching service may identify an optimally cost-effective pathway between CAD and SEK based on the most recent quotes of price and liquidity provided in step S1. In the example of FIG. 2, the selected pathway is CAD/USD→USD/EUR→EUR/SEK. It will be appreciated that each time an FX conversion is made, a bid-ask spread is dealt with. However, the spreads quoted by the liquidity providers 402 are much lower than the spread quoted in customer FX rates, as described with respect to FIG. 1. Note that the spreads quoted by a liquidity provider are lower than customer spreads for several reasons. The bid and ask prices are selected in a transparent and competitive market, and are quoted for real-time settlement by banks with surplus liquidity in the sell currency. Note that if settlement is not real-time, for example if an FX buy/sell order is accepted at a particular price but a corresponding seller/buyer is not found immediately, the value of a currency in the pair may change in that time, which may cause the intermediate party to lose money. By increasing the bid-ask spread, an intermediate party protects itself from losing money in this way. However, if settlement is in real-time, spreads can be much smaller because there can be no deviation in currency value as the transfer is made.

A customer rate spread may be of the order of 100 times larger than the spreads quoted by the liquidity providing banks 402. Since the currency pair pathway determined in step S5 would not require of the order of 100 currency pair steps, the cost of FX conversion in the example of FIG. 2 incurs much reduced costs compared to the method described with respect to FIG. 1, even if only one currency pair is traversed at the customer spread. However, even using traditional methods, such as that illustrated in FIG. 1, more than one intermediate currency pair may be required for a transaction to be made, further increasing the difference in cost. At a step S6, the facilitating computer system 406 communicates with all parties involved in the transaction to arrange settlement. That is, the sending bank 416, the selected liquidity providers 402, and the receiving bank 418 are instructed by the facilitating computer system 406.

At a step S7, a plurality of escrow accounts, third party accounts for temporarily holding funds while a transaction is carried out, may be funded by the parties involved in the transaction. The escrow accounts are used to ensure simultaneous settlement across the entire transaction chain, with each individual leg settled via a pair of local Real Time Gross Settlement (RTGS) payments between two involved parties: one to the escrow account, and one from the escrow account when all escrow accounts have been funded. Note that the four RTGS payments shown in FIG. 2 are labelled “LTVS”, “Fedwire”, “T2” and “RIX” respectively. Each label simply refers to the name of the RTGS payment system in each jurisdiction. For example, in FIG. 2, the sending bank (SB) 416 funds an escrow account operated by the coordinating party in Canada, where “LTVS” refers to the RTGS system of the Canadian dollar. Liquidity provider LP2, which has been selected to perform the CAD/USD FX conversion, funds an escrow account operated by the Coordinating Party in the US under the Fedwire RTGS system, used for USD. LP6 funds an escrow account operated by the Coordinating Party under the T2 RTGS system, used for EUR. Finally, LP7 funds an escrow account operating under the RIX RTGS system that is used for SEK; This escrow account may be configured to transfer funds to the recipient bank when payment is activated.

Only when all parties have funded an escrow account, in the currency they have contracted to deliver, are funds transferred to the receiving parties, including the supplier's bank 418 in a step S8. That is, a synchronous payment versus payment (PvP) settlement occurs when all escrow accounts are funded.

In a ninth step S9, the sending bank is the beneficial owner of funds in an escrow account held with the coordinating party, who operates the facilitating computer system 406. The coordinating party makes a domestic RTGS payment to the receiving bank 418 in SEK. Note that step nine S9 is only labelled as a distinct step from step eight S8 because the type of payment is different. The transactions represented by S8 are treasury transactions between liquidity providers and the transaction represented in S9 is a domestic payment. However, it should be appreciated that S8 and S9 are interdependent and occur synchronously. The transactions of both S8 and S9 are dependent on the funding of all escrow accounts at S7, and both S8 and S9 are simultaneously triggered by an identification that the escrow account funding step of S7 has been completed. In fact, the nature of a PvP payment is that each transaction depends on all others, thus execution of S8 is dependent on execution of S9, and vice versa.

Finally, in a step S10, the receiving bank performs a compliance check on the transaction before crediting the account held by the Swedish supplier.

It will be appreciated that there are many benefits to the above-described method, particularly in view of the industry standard method described with respect to FIG. 1. In addition to reduced costs and transaction timescales, the transaction is not dependent on a plurality of negotiated arrangements between banks, and is easily traceable. Further, settlement occurs without risk, using money held in central banks with high liquidity and, since the RTGS payments are made on a gross basis (transaction by transaction), a transaction performed via the method shown in FIG. 2 provides legal finality.

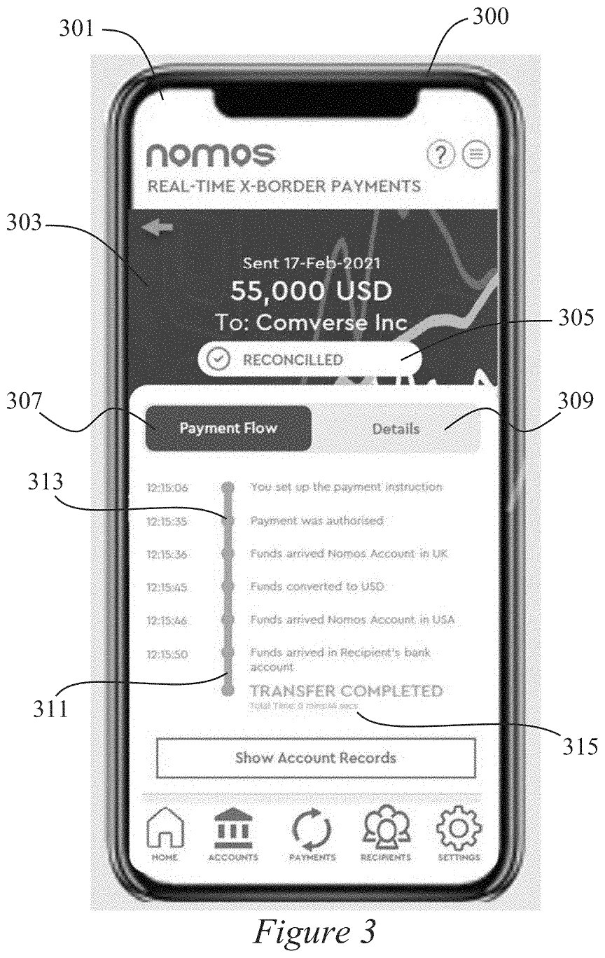

FIG. 3 shows a user device 300 displaying an exemplary user interface 301 configured to provide visual indicators of transaction progress. In the example of FIG. 3, a cross-border payment instruction has been received, and the user interface 301 shows a visual representation of the progress of the cross-border payment instruction. In some embodiments, the user interface 301 may be provided by a third party (e.g., the coordinating party in the description of FIG. 2) and embedded within a mobile application or web interface provided by a bank, such as an online banking application or web interface. In such an embodiment, user input of a cross-border payment instruction may be received at a different user interface (not shown) than the user interface 301 of FIG. 3. The different user interface may be provided, for example, by the sending bank or by the coordinating party and configured to transmit payment instructions to a transaction system. Upon transmission of a payment instruction, an instance of the user interface 301 may then be rendered on the user device 300, allowing the user to monitor the progress and state of the transaction.

The user interface 301 comprises an overview panel 303 configured to display a summarised report of the payment and its progress status. The overview panel 303 shows the transaction date and the amount to be transferred, identifies the receiving party, and displays a status indicator 305 which, in the example of FIG. 3, indicates that the payment has been reconciled and is complete.

The user interface 301 further comprises a payment flow tab 307 and a details tab 309, the payment flow and details tabs 307, 309 being selectable user interface features. Upon selection of the payment flow tab 307, a visual representation of the progress of the transaction is rendered on the user interface, as shown in FIG. 3. Upon selection of the details tab 309, details pertaining to the payment instruction may be rendered on the user interface. Note that the currently selected tab (payment flow tab 307, in the example of FIG. 3) may include a selection indicator, such as a colour or texture, which indicates that that tab is selected.

When the payment flow tab 307 is selected, the user interface 301 displays a transaction flow 311, the transaction flow 311 comprising a plurality of event markers 313. Each event marker 313 is a graphical indication of a transaction step in the transaction process. In the example of FIG. 3, the transaction flow 311 is shown as a vertical line and each transaction step is represented by a circular event marker 313 on the vertical line. Each event marker 313 also corresponds to a line of text that identifies a corresponding transaction step. The final event marker 313 on the transaction flow 311 may include a time indicator 315. The time indicator 315 shows the user how much time elapsed between confirmation of the payment instruction and confirmation that the funds are received by the receiving party.

Each event marker 313 may be a selectable user interface feature which, when selected, causes the user interface to display further details pertaining to the transaction step associated with the selected event marker 313.

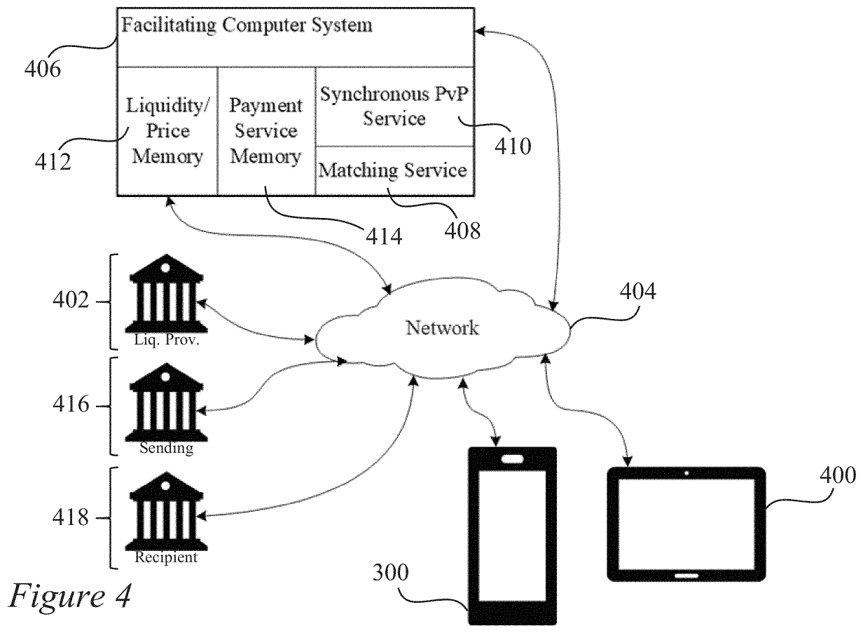

FIG. 4 shows an exemplary overall environment configured to make a cross-border transaction in accordance with the method described with reference to FIG. 2. FIG. 4 shows a facilitating computer system 406 configured to implement the cross-border payment method. The facilitating computer system 406 may receive data, transmit data, and execute the payment method via a network 404, such as the internet.

FIG. 4 also shows a first client device 300 and a second device 400, wherein the first client device 300 is the same client device as is described with reference to FIG. 3. The client devices, 300 and 400, are in communication with the facilitating computer system 406 via the network 404. It will be appreciated that although two client devices are shown in FIG. 4, any number of client devices may be connected to the network, and more than one device may be associated with a particular user. In the example of FIG. 4, the first client device 300 is a smartphone device, and the second client device 400 is a tablet computer. When a particular user provides a payment instruction, the user's corresponding client device(s) 300, 400 may allow the user to monitor the progress of a transaction, for example through a user interface, such as the one shown in FIG. 3.

FIG. 4 shows a bank icon, which represents a plurality of liquidity providers 402, the liquidity providers 402 providing price and liquidity data for selected currency pairs, based on funds held with central banks. The liquidity and price data may be provided via the network 404 to a liquidity/price memory component 412 in the facilitating computer system 406. Note that liquidity and price data stored in the liquidity/price memory component 412 may be overwritten each time a new quote is received from the liquidity providers 402, allowing the latest price and liquidity data to be used when determining the currency pathway. Each liquidity provider 402 may also communicate with the facilitating computer system 406 via the network 404 to send a completion indication each time a transaction step is completed.

FIG. 4 also shows a generic sending bank 416 and a generic recipient bank 418. Note that the generic sending bank 416 and generic recipient bank 416 are not specific to a particular user or transaction, and merely represent arbitrary sending and recipient banks. The sending bank 416 and recipient bank 418 are in communication with the facilitating computer system 406 via the network 404, for example to receive settlement instructions and to send a completion indication each time a transaction step is completed. The sending bank 416 also communicates with the client devices 300, 400 via the network to receive payment instructions.

As described previously, the application or web interface through which a sending user instructs and monitors cross-border payments may be embedded within an application provided by the sending bank of the sending user, wherein the application or web interface runs on the user device 300. In such an embodiment, the facilitating computer system 406 may communicate with the sending bank 416 via the network 404 to update the user interface 301, based on completion indications received from the liquidity providers 402, the sending bank 416 and/or the recipient bank 418. When, for example, the transaction flow 311 of FIG. 3 is updated on the user interface 301, the sending bank 416 may communicate directly with the client device 300 via the network 404 to provide the updated embedded user interface.

The facilitating computer system 406 comprises a payment service memory 414, which may hold client data for authentication, screening and other security purposes. The payment service memory may also hold a data structure which stores data pertaining to escrow accounts that exist for each currency pair through which a currency pathway may pass.

The facilitating computer system 406 also includes a matching service module 408 and a synchronous PvP service module 410. Note that the synchronous PvP service module may also be referred to as the synchronous settlement module 410. The matching service module 408 is configured to run an algorithm that determines the optimal currency pathway through currency pairs for a particular transaction, based on the latest liquidity/price data supplied by the liquidity providers 402, which is stored in the liquidity/price memory component 412. The synchronous settlement module 410 is configured to provide settlement instructions to the selected liquidity providers 402, the sending bank 416 and the recipient bank 418. The settlement instructions may be based on user data and escrow data stored in the payment service memory component 414, and based on the output of the matching service component 408. That is, the synchronous PvP service module 410 may define, for each of multiple transaction pairs in the selected currency conversion pathway, an escrow account for receiving funds from a first currency member of each transaction pair. Further, the synchronous settlement module 410 may be configured to release from each escrow account the funds received from a first party of each transaction pair to a second party of each transaction pair in a settlement timeframe.

The settlement instructions provided by the synchronous settlement module 410 to the liquidity providers 402 may define a funding window of a predefined length of time, within which each liquidity provider is expected to fund the escrow account of which they are the first party in the transaction pair. For instance, in the example of FIG. 2, LP2 is the first party in a transaction pair with LP6, operating under the Fedwire RTGS system. A settlement instruction provided by the synchronous settlement module 410, may therefore define a funding window of, for example, thirty minutes in which funds must be provided by LP2 to the escrow account that it holds with LP6. Incoming payments received at each escrow account may be identified by associated with payment message data, which may be received by the synchronous settlement module 410, indicating that the payment has been received. Note that payment message data associated with each payment may be standardised to the RTGS system of the local central bank. A push or fetch system may be implemented to identify receipt of payment message data for each escrow account; this allows a short timeframe between transfer of funds and identification by the synchronous settlement module 410 of the receipt of the funds.

If one or more incoming payments to an escrow account is not identified within the funding window identified in the settlement instructions, the transaction is cancelled and all received funds are returned to the sender upon issuance of a payment instruction by the coordinating party, sent, for example, by the synchronous settlement module 410. Each liquidity provider from which the coordinating party receives and stores data (that is, each liquidity provider which could in theory be used to facilitate a cross-border payment through the method described herein) may be associated with a reputation score.

The reputation score of particular liquidity provider may be stored in association with other data pertaining to that liquidity provider, for example in a data structure held in the payment service memory 414. The reputation score of a particular liquidity provider may be a numerical value, the value based on a historical record of cooperation demonstrated by the liquidity provider. For example, a reputation score may be indicative of a rate of unsuccessful payments for which the associated liquidity provider was responsible, e.g., by failing to provide funds within the predefined funding window. The data structure comprising reputation scores for each liquidity provider may be updated each time a cross-border payment is made, the reputation scores of each liquidity provider involved in the payment being modified (e.g., increased or decreased) to reflect their performance in the payment. A comparison between reputation scores and a predefined threshold reputation score may be conducted by the matching service 408. If the reputation score of a particular liquidity provider falls below the predefined threshold, that liquidity provider may cease to be selected for participation in future payments.

When all liquidity providers 402 have funded the escrow account of which they are the first party in the transaction pair, and therefore all necessary payment message data is received at the synchronous settlement module 410, instructions to send the settled funds to the correct account (held by the second party in a given transaction pair) may be immediately issued. At this point, the series of synchronous PvP payments may take place. If all RTGS systems are open, the settlement may take 1 second or less to complete. If one or more of the RTGS systems is not open, all funds may be held in the escrow accounts until all RTGS systems are open, allowing a synchronous PvP settlement across the relevant accounts of all involved parties.

An RTGS system does not need to be open in order to conduct a settlement. However, transfers into an escrow account do require that the RTGS be open. A liquidity provider may choose to pre-fund escrow accounts such that settlement may still be conducted when its associated RTGS is closed.

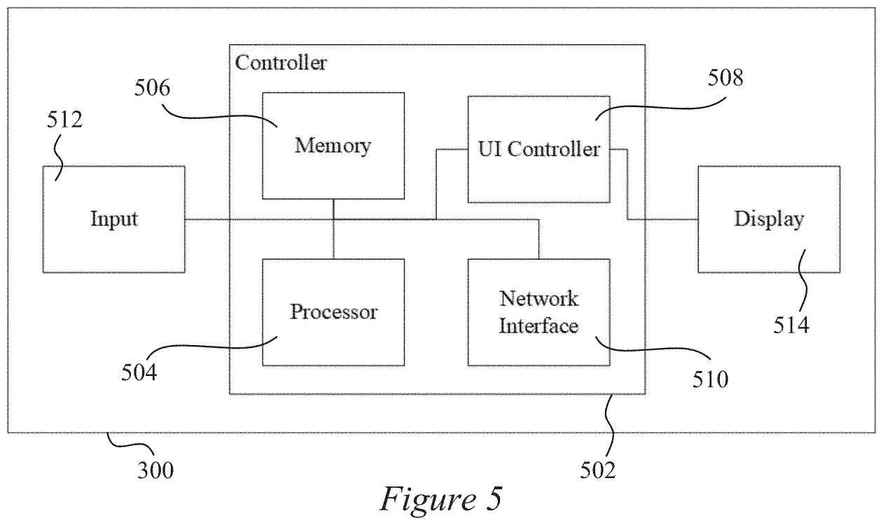

FIG. 5 shows a highly schematic block diagram of a client or computing device 300. The client device 300 comprises a controller 502. The controller 502 may have one or more processor 504 and one or more memories 506. The controller 502 further comprises a network interface 510 allowing the device 300 to be able to communicate with a network such as the internet, or a different communication infrastructure.

The client device 300 further includes a user interface controller 508 and a display 514, the user interface controller configured to control the layout of information on the display 514. The client device 300 includes an input device 512. The input device 512 can take any suitable format, such as one or more of: a keyboard, mouse or touch screen. It should be appreciated that the display 514 may in some embodiments also provide the input device 512, for example, by way of an integrated touch screen. The functional components of the controller 502 are configured to communicate with each other via an interconnect such as a bus or any other suitable interconnect and/or by point-to-point communication. Note that other functional components may also be implemented by suitable circuitry or computer code executed by the one or more processor 504.

1. A computer system for controlling financial transactions between a sending entity and a receiving entity, the computer system comprising:
an input for receiving an electronic instruction message comprising a cross-border payment instruction defining a first sender currency and a second recipient currency;
a matching service module configured to receive transaction data from a plurality of currency providers and to select a pathway of currency conversions between the sender currency and the recipient currency, the selected pathway comprising selected currency providers;
a first output for issuing settlement instructions to each of the selected providers on the selected currency conversion pathway; and
a second output for issuing a payment instruction to the receiving entity to issue payment to a recipient in the receiving currency.

2. The computer system of claim 1 comprising a synchronous settlement module which defines for each of multiple transaction pairs in the selected currency conversion pathway, an escrow account for receiving funds from a first currency member of each transaction pair.

3. The computer system of claim 2 wherein the synchronous settlement module is configured to release from each escrow account the funds received from the first party of each transaction pair to the second party of each transaction pair in a settlement timeframe.

4. The computer system of claim 3 wherein the synchronous settlement module is configured to release the funds from each escrow account contingent on each of the escrow accounts being funded.

5. The computer system of claim 4 wherein the settlement timeframe is a defined time period after each of the escrow accounts have been funded.

6. The computer system of claim 3 comprising computer memory holding a data structure which defines each transaction pair with its associated escrow account for the selected currency conversion pathway.

7. The computer system of claim 6 wherein the computer memory is configured to clear each transaction pair and its associated escrow account from an active memory location after the settlement timeframe.

8. The computer system of claim 7 comprising an archive memory for recording the data structure for future analysis.

9. The computer system of claim 1 which is configured to receive the transaction data from multiple geographically separate locations.

10. The computer system of claim 9 wherein the separate locations are in different countries.

11. The computer system of claim 1 configured, where parties fail to fund an associated escrow account, to use a reputation score to assess future use of that currency provider.

12. The computer system of claim 1 wherein the second output comprises an instruction for a domestic payment from a respondent bank in a geographical location corresponding to the location of the recipient.

13. The computer system of claim 1 wherein the transaction data comprises price data defining the exchange rate between the currencies to be converted at each currency provider and liquidity data defining the liquidity of the currency provider.

14. The computer system of claim 1 comprising a compliance screening function configured to screen the payment instruction at the input, and create a standardised output format for presentation in a relevant manner to all eligible parties.

15. The computer system of claim 14 wherein the standardised format is one or both of language and character set.

16. The computer system of claim 1 comprising an application programming interface (API) configured to provide transaction data to one or more client computing device via a communication network.

17. A computer device for tracking transaction details of a financial transaction, the computer device comprising:
a user interface configured to receive a cross-border payment instruction from a user;
a network interface configured to connect the computer device to a transaction system via a communication network and to transmit the payment instruction to the transaction system; and
a processor configured to receive data defining transaction steps from the transaction system when the transaction is being enacted in accordance with the payment instructions and to render graphical indicators of the respective transaction steps on a display of the user interface, wherein each graphical indicator is selectable by the user and, when selected, causes the processor to display underlying transaction information pertaining to that transaction step.

18. The computer device of claim 17, wherein the transaction steps include receipt of the payment instruction.

19. The computer device of claim 17, wherein the transaction steps include authorisation of the financial transaction.

20. The computer device of claim 17, wherein the transaction steps include receipt of funds at a sending bank in the sending currency.

21. The computer device of claim 17, wherein the transaction steps include conversion of funds into a recipient currency.

22. The computer device of claim 17, wherein the transaction steps include receipt of funds at a recipient bank in a recipient currency.

23. The computer device of claim 17, wherein the transaction steps include receipt of funds by a recipient entity.

24. The computer device of claim 17, wherein the transaction steps include completion of the transaction.

25. The computer device of claim 17, configured to provide reports to support transaction failure events and recovery of funds.

26. A method for controlling financial transactions between a sending entity and a receiving entity, the method comprising:
receiving input of an electronic instruction message comprising a cross-border payment instruction defining a first sender currency and a second recipient currency;
receiving at a matching service module transaction data from a plurality of currency providers and selecting a pathway of currency conversions between the sender currency and the recipient currency, the selected pathway comprising selected currency providers;
issuing settlement instructions to each of the selected providers on the selected currency conversion pathway; and
issuing a payment instruction to the receiving entity to issue payment to a recipient in the receiving currency.

27. Non-transitory computer readable media on which are stored computer readable instructions which, when executed by a processor of a computer device, cause the processor to implement the method of claim 26.

28. A computer system for controlling financial transactions between a sending entity and a receiving entity, the computer system comprising:
an input for receiving an electronic instruction message comprising a cross-border payment instruction defining a first sender currency and a second recipient currency;
a matching service module configured to receive transaction data from a plurality of currency providers and to select a pathway of currency conversions between the sender currency and the recipient currency, the selected pathway comprising selected currency providers; and
a fund settlement service comprising one or more hardware processor configured to send:
a first set of instructions comprising requests to funding providers to send funds to respectively corresponding escrow account(s);
a second set of instructions to each of multiple settlement accounts to pay out settled funds to nominated accounts of the currency providers; and
a third instruction comprising a payment instruction to the receiving party on a domestic real time gross settlement service.
